(19) United States
(12) Patent Application Publication
(10) Pub. No.: US 2009/0172012 A1
(43) Pub. Date: Jul. 2, 2009

(54) Methodology to derive enterprise relationships for generating a topology view in a SOA environment

(76) Inventors: Sudhakar V. Chellam, Apex, NC (US); David E. Cox, Raleigh, NC (US); Michael F. Fiedler, Apex, NC (US); John L. Harter, Cary, NC (US); Rosalind Toy Allen Radeliffe, Durham, NC (US)

Correspondence Address: HAMILTON & TERRILE, LLP;IBM RSW, P.O. BOX 203518, AUSTIN, TX, 78720, US

(21) Appl. No.: 11/966,855

(22) Filed: Dec. 28, 2007

(51) Int. Cl. G06F 7/04; G06F 17/30

(52) U.S. Cl. 707/103 R; 707/E17.055

(57) ABSTRACT

A method for generating a topology of a service oriented architecture (SOA) environment comprises associating a unique identifier with each entity within the SOA environment. The unique identifier summarizes attribute data of a respective entity. The relationships between the unique identifiers are used to derive a topology of the SOA environment.

### BACKGROUND OF THE INVENTION

The present invention relates in general to data processing systems and in particular to deriving enterprise relationships in a service oriented architecture environment for generating a topological view of the enterprise.

It is known to organize data processing systems within a service oriented architecture (SOA) environment. A Service Oriented Architecture environment builds applications out of software services. The software services can include intrinsically unassociated units of functionality, which have no calls to each other embedded in them. It is known to generate topological views for use in an SOA environment.

With known methods of generating topological views, the topological views are derived from a single attribute such as the hostname, ip address or the type of network on which an entity participates. The actual attribute values are often required to draw the topology. Examples of attribute values needed to draw the topology include an internet protocol (ip) address and a port number of the application. This information is used to display the topology.

When generating topological views, many methods analyze all messages in a SOA environment to derive the topological view of the message paths. In these methods, a centralized server often provides the identity of the interception points to derive the topology. However, known methodologies often include limitations due to the amount of data to be collected, work required to process all messages, or a centralized system is required to coordinate collection of the interception point attributes.

### BRIEF SUMMARY OF THE INVENTION

In one embodiment, the invention relates to a method for generating a topology of a service oriented architecture (SOA) environment which includes associating a unique identifier with each entity within the SOA environment wherein the unique identifier summarizes attribute data of a respective entity, passing the unique identifier from one entity within the SOA environment to another entity within the SOA environment via an SOA message so as to identify a relationship between the one entity and the another entity, and using the relationship between the one entity and the another entity of the SOA environment to derive a topology of the SOA environment.

In another embodiment, the invention relates to a computer program product for generating a topology of a service oriented architecture (SOA) environment. The computer program product includes a computer usable medium having computer usable program code embodied therewith and computer usable program code configured to use the relationship between the one entity and the other entity of the SOA environment to derive a topology of the SOA environment. The computer usable program code includes computer usable program code configured to associate a unique identifier with each entity within the SOA environment wherein the unique identifier summarizes attribute data of a respective entity, and computer usable program code configured to pass the unique identifier from one entity within the SOA environment to another entity within the SOA environment via an SOA message so as to identify a relationship between the one entity and the another entity.

In another embodiment, the invention relates to a system which includes a processor, a data bus coupled to the processor, a module for associating a unique identifier with each entity within a SOA environment, a module for using recorded relationships between unique identifiers to derive a topology of the SOA environment, and a module for generating a topology of the SOA environment based upon the derived topology. The unique identifier summarizes attribute data of a respective entity.

### BRIEF DESCRIPTION OF THE SEVERAL VIEWS OF THE DRAWINGS

FIG. 1 depicts an exemplary client computer in which the present invention may be implemented;

FIG. 2 depicts a block diagram of information used by a SOA topology system;

FIG. 3 depicts a block diagram of example communications within a SOA environment;

FIG. 4 depicts a flow chart of the operation of a SOA topology system; and

FIG. 5 shows an example screen presentation of a topology view generated by a SOA topology system.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

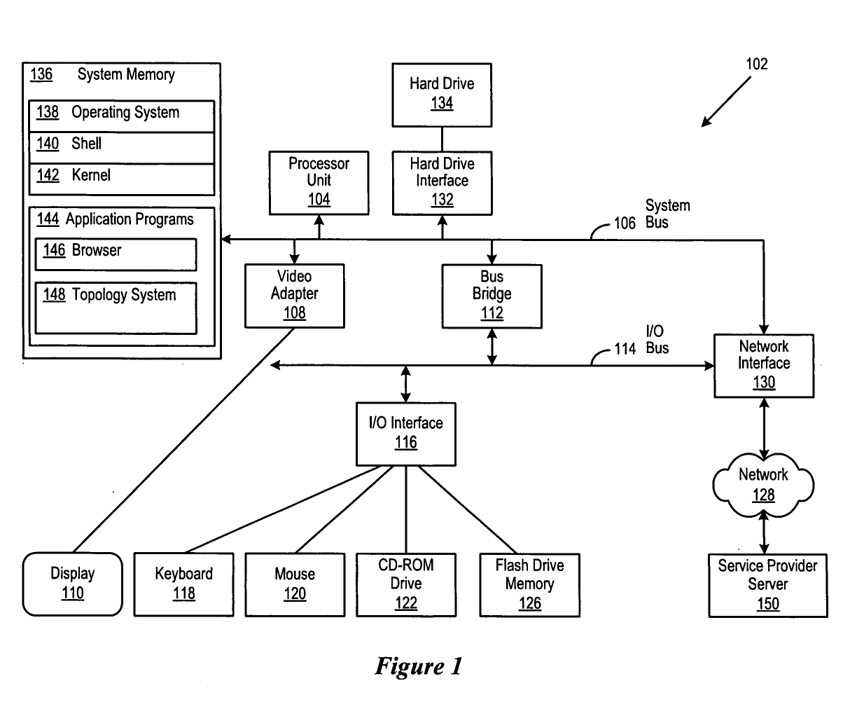

With reference now to FIG. 1, there is depicted a block diagram of an exemplary computer 102, in which the present invention may be utilized. Computer 102 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 416 may be any known to those skilled in the art of computer architecture, including but not limited to Universal Serial Bus (USB) ports.

Computer 102 is able to communicate with a service provider server (which may also be a computer 150) via a network 128 using a network interface 130, which is coupled to system bus 106. Network 128 may be an external network such as the Internet, or an internal network such as an Ethernet or a Virtual Private Network (VPN). Using network 128, computer 102 is able to use the present invention to access service provider server 150.

A hard drive interface 132 is also coupled to system bus 106. Hard drive interface 132 interfaces with a hard drive 134. In one aspect of the present invention, hard drive 134 populates a system memory 136, which is also coupled to system bus 106. Data that populates system memory 136 includes client computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (as it is called in a UNIX® operating system also called a command processor in a Microsoft® Windows® operating system, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a browser 146. Browser 146 includes program modules and instructions enabling a World Wide Web (WWW) client (i.e., computer 102) to send and receive network messages to the Internet using HyperText Transfer Protocol (HTTP) messaging, thus enabling communication with service provider server 150.

Application programs 144 in client computer 102's system memory also include a SOA topology system 148. The SOA topology system 148 includes code for implementing the processes described below. In one embodiment, computer 102 is able to download the SOA topology system 148 from service provider server 150.

The hardware elements depicted in computer 102 are not intended to be exhaustive, but rather are representative to highlight essential components required by the present invention. For instance, computer 102 may include alternate memory storage devices such as magnetic cassettes, Digital Versatile Disks (DVDs), Bernoulli cartridges, and the like. These and other variations are intended to be within the spirit and scope of the present invention.

As noted above, the SOA topology system 148 can be downloaded to a client computer from service provider server 150. Additionally, in one aspect of the present invention, service provider server 150 performs all of the functions associated with the present invention (including execution of the SOA topology system 148), thus freeing a client computer 102 from using its resources.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as but not limited to Random Access Memory (RAM), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

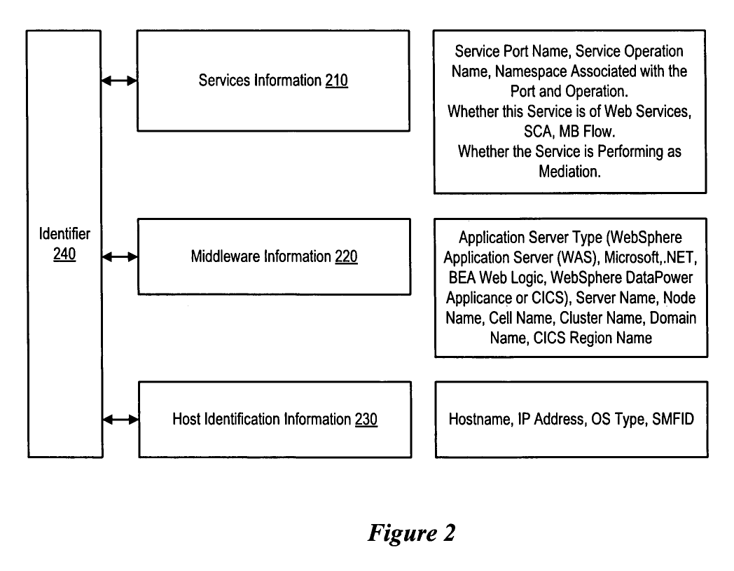

FIG. 2 depicts a block diagram of information used by the SOA topology system 148. More specifically, the SOA topology system 148 includes services information 210, middleware information 220 and host identification information 230. The SOA topology system 148 includes an identifier 240. This identifier 240 is generated from the information 210, the middleware information 220 and the host information 240. The identifier 240 can be regenerated consistently with the same information.

Examples of information included within the services information 210 include a service port name, a service operation name, a namespace associated with the port and operation, whether the service is a web service, Service Component Architecture (SCA), Message Broker (MB) flow and whether the service is performing as mediation. Examples of information included within the middleware information 220 include an application server type (e.g., WebSphere Application Server (WAS), Microsoft, .NET, BEA Web Logic, WebSphere DataPower Applicance or CICS), a server name, a node name, a cell name, a cluster name, a domain name and a CICS region name. Examples of information included within the host identification information include a host name, an IP address, and an OS type.

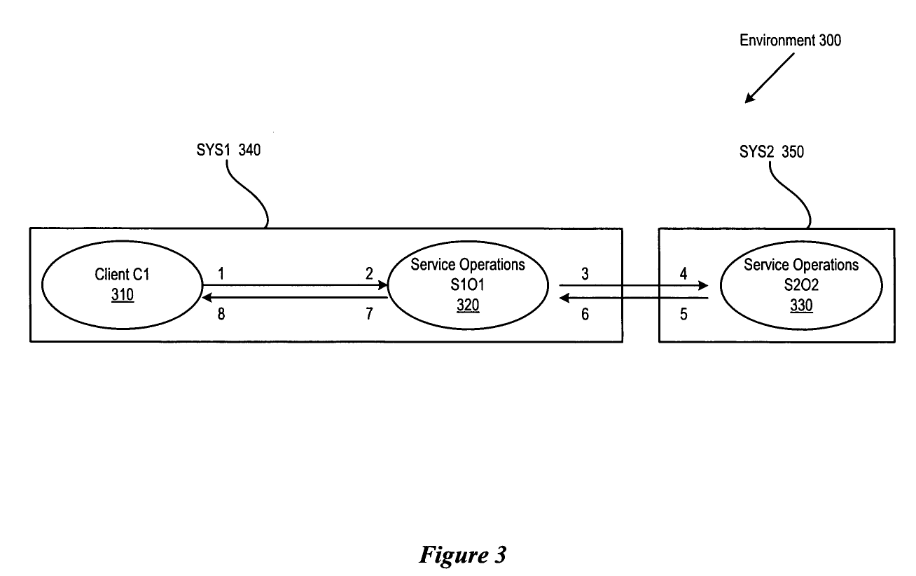

FIG. 3 depicts a block diagram of example communications within a SOA environment. More specifically, in an example SOA environment, a client C1 310 communicates via a service S1O1 320 with another service S2O2 330. The client C1 and service S1O1 are executing on a first physical system SYS1 340 and the service S2O2 is executing on a second physical system SYS2 350.

By using the SOA topology system 148, each entity within the SOA environment 300 (e.g., the client C1, the service S1O1 and the service S2O2) is identified through identifiers. These identifiers are generated from the data in the interception points. The interception points are where components have control in the message path. The messages that need to be passed between the interception points do not have to contain all of the attribute data that is necessary to derive the relationship view. The identifiers summarize all attribute data that represents the interception location or the entity, which participates in the relationship.

For example, if the service operation S1O1 and S2O2 are Web services executing in two different physical systems and Client C1 invokes the service S1O1 in the system SYS1. Next, the service S1O1, as a part of business logic, invokes another service S2O2. There is a relationship between the services. Using the SOA topology system 148, a unique identifier is generated for each interception. The interception points are defined as points where the service request was originated, the provider received the request, the provider originated the response, and the originator of the request received the response. The unique identifier is generated from the information available at each interception point. The unique identifier generated at and passed between these interception points are used to identify relationships between the entities.

The unique identifier is generated based upon information derived from the SOA Messages. More specifically, this information includes environment information such as the system name, application Server name, application server node name, cell name, Web Services Port Name, Web Services namespace, Web Services Operation Name, Web Services Operation Name space. A universal resource indicator (URI) is generated using this information and from the URI the unique identifier is generated.

The unique identifiers for a topology are stored in form of relationships in each of the nodes. The relationships and the unique identifiers are then used by the topology system 148 at a global level to derive the relationship topology. These unique relationships can be retrieved from the interception points and the topology can be drawn in a user interface using the relationship data from different nodes. The topology system 148 thus does not have to look at each single message to derive the topology at the UI. The topology system 148 derives the relationships at an abstract level.

Using the example shown in FIG. 3, at SYS1 the relationships that are stored include Requestor CC1 to S1O1, Provider CC1 to S1O1. At SYS2, the relationships that are stored include Provider S1O1 to S2O2 and Requester S1O1 to S2O2.

The topology system 148 derives these relationships by analyzing the provider of the messages (i.e., in the example of FIG. 3, CC1 to S1O1 and S1O1 to S2O2). Using the stored relationships, the topology can be derived as CC1->S1O1->S2O2. Such a derivation enables the generation of a topology view easily in case of services and application relationships.

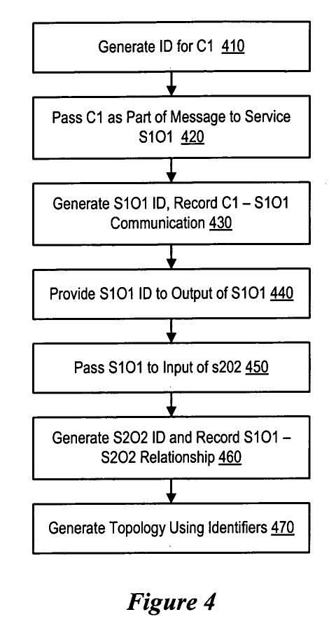

FIG. 4 depicts a flow chart of the operation of the SOA topology system 148 when generating a topology for the example environment 300. More specifically, when the client C1 invokes the service S1O1, the topology system 148 creates a unique identifier for the client at step 410. Next the unique identifier for C1 is passed as part of the message to the service S1O1 at step 420. Next the topology system 148 generates a unique identifier for the service S1O1 and records the relationship between the C1 and S1O1 identifiers at step 430. Next the topology system 148 provides the S1O1 identifier to the message of the service S1O1 at step 440. The S1O1 identifier is then passed as part of the message to the service S2O2 at step 450. Next, the topology system 148 generates a unique identifier for the service S2O2 and records the relationship between the S1O1 and S2O2 identifiers at step 460. The topology system 148 can then generate a topology of the SOA environment using the recorded relationships between unique identifiers at step 470.

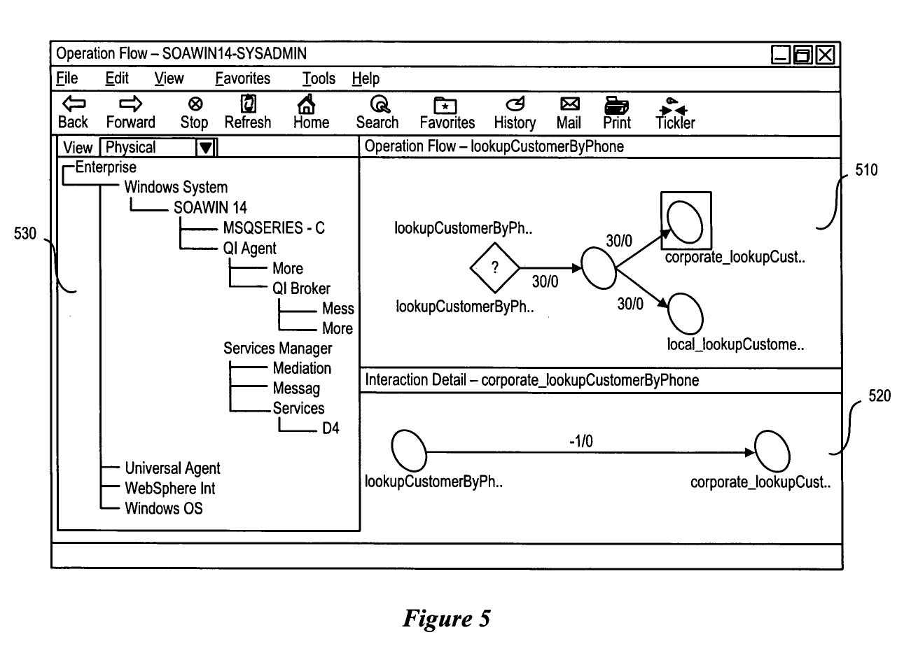

FIG. 5 shows an example screen presentation of a topology view generated by a SOA topology system using the relationship information described and recorded in this patent filing. More specifically, the topology system 148 generates a plurality of topology presentations using the identifier for a particular SOA environment. The topology presentations include an operation flow presentation 510, an interaction detail presentation 520 and a physical environment presentation 530. The operation flow presentation 510 provides a presentation of the operation flow of the SOA environment. The interaction detail presentation 520 provides a presentation of the interaction detail of each of the elements within the SOA environment. The physical environment presentation provides the actual physical topology of the SOA environment.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method for generating a topology of a service oriented architecture (SOA) environment comprising:
associating a unique identifier with each entity within the SOA environment; the unique identifier summarizing attribute data of a respective entity;
passing the unique identifier from one entity within the SOA environment to another entity within the SOA environment via an SOA message so as to identify a relationship between the one entity and the another entity; and,
using the relationship between the one entity and the another entity of the SOA environment to derive a topology of the SOA environment.

2. The method of claim 1 further comprising:
recording an association between two unique identifiers at each interception point within the SOA environment and using the association to identify a relationship between entities at the interception point.

3. The method of claim 2 wherein:
the interception point comprises a point where a service request is originated, a provider received the service request, the provider originates a response and an originator of the request receives the response.

4. The method of claim 1 further comprising
generating the unique identifier based upon information derived from messages between entities in the SOA environment and the runtime environment in which those messages are observed.

5. The method of claim 4 wherein:
the information comprises at least one of a system name, an application server name, an application server node name, a cell name, a web services port name, a web services namespace, a web services operation name, and a web services operation name space.

6. The method of claim 4 further comprising:
generating a universal resource indicator based upon the information derived from messages between entities in the SOA environment.

7. A computer program product for generating a topology of a service oriented architecture (SOA) environment, the computer program product comprising:
a computer usable medium having computer usable program code embodied therewith, the computer usable program code comprising:
computer usable program code configured to associate a unique identifier with each entity within the SOA environment; the unique identifier summarizing attribute data of a respective entity; and,
computer usable program code configured to pass the unique identifier from one entity within the SOA environment to another entity within the SOA environment via an SOA message so as to identify a relationship between the one entity and the another entity; and,
computer usable program code configured to use the relationship between the one entity and the another entity of the SOA environment to derive a topology of the SOA environment.

8. The computer program product of claim 7 wherein computer usable program code further comprises:
computer usable program code configured to record an association between two identifiers at each interception point within the SOA environment to identify a relationship between entities at the interception point.

9. The computer program product of claim 8 wherein:
the interception point comprises a point where a service request is originated, a provider received the service request, the provider originates a response and an originator of the request receives the response.

10. The computer program product of claim 8 further comprising:
computer usable program code configured to generate the unique identifier based upon information derived from messages between entities in the SOA environment and the runtime environment in which the messages are observed.

11. The computer program product of claim 10 wherein:
the information comprises at least one of a system name, an application server name, an application server node name, a cell name, a web services port name, a web services namespace, a web services operation name, and a web services operation name space.

12. The computer program product of claim 10 further comprising computer usable program code configured to generate a universal resource indicator based upon the information derived from messages between entities in the SOA environment.

13. A system comprising:
a processor;
a data bus coupled to the processor; and
a module for associating a unique identifier with each entity within a SOA environment; the unique identifier summarizing attribute data of a respective entity; and,
a module for using recorded relationships between unique identifiers to derive a topology of the SOA environment; and,
a module for generating a topology of the SOA environment based upon the derived topology.

14. The system of claim 13 further comprising:
a module for recording an association between unique identifiers at each interception point within the SOA environment to identify a relationship between entities at the interception point.

15. The system of claim 14 wherein:
the interception point comprises a point where a service request is originated, a provider received the service request, the provider originates a response and an originator of the request receives the response.

16. The system of claim 13 wherein:
the unique identifier is generated based upon information derived from messages between entities in the SOA environment and the runtime environment in which those messages are observed.

17. The system of claim 16 wherein:
the information comprises at least one of a system name, an application server name, an application server node name, a cell name, a web services port name, a web services namespace, a web services operation name, and a web services operation name space.

18. The system of claim 16 wherein:
a universal resource indicator is generated based upon the information derived from messages between entities in the SOA environment.
